(19) United States
(12) Patent Application Publication
(10) Pub. No.: US 2006/0089998 A1
(43) Pub. Date: Apr. 27, 2006

(54) Method and system for determining server having controlling function

(75) Inventors: Young-Ae Kim, Seoul (KR); Young-Hwan Park, Seoul (KR); Kang-Suk Huh, Gyeonggi-do (KR); Hee-Joung Lee, Gyeonggi-do (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/253,570

(22) Filed: Oct. 20, 2005

Related U.S. Application Data
(60) Provisional application No. 60/621,589, filed on Oct. 22, 2004.

(30) Foreign Application Priority Data
Jan. 19, 2005 (KR) 10-2005-005155

(51) Int. Cl. G06F 15/16

(52) U.S. Cl. 709/229

(57) ABSTRACT

A method and system for determining a server having a controlling function, are provided. The method includes determining which server serves most clients invited to a session among at least two different servers serving at least two clients, and designating the determined server to be a server having a controlling function.

This application claims priority, under 35 U.S.C. §119, on U.S. Provisional Application No. 60/621,589 filed on Oct. 22, 2004, and Korean Patent Application No. 10-2005-0005155 filed in Republic of Korea on Jan. 19, 2005. The entire contents of each of these applications are hereby incorporated by reference.

### BACKGROUND OF THE INVENTION

1. Field of the Invention

The present invention relates to a PT (push-to) service, and more particularly, to a method and system for determining a server having a controlling function capable of allocating a controlling function to a PT server serving a PT server region having the most session-established PT clients.

2. Description of the Related Art

A PT service is intended to provide rapid communications for business and consumers of mobile networks. The PT service can be a push to talk over cellular (PoC) for providing a call service by sending voice data, a push to view (PTV) for sending moving picture (video) data, or a communication service such as a push to data (PTD) for sending data. In a PT service system, a PT client (e.g., a client supporting a PT service) that wishes to transmit media data (voice, video, data, etc.) needs to first have an authority/permission to transmit the media data. Thus, prior to the actual transmission of the media data (talk burst), the PT client that wishes to transmit the media data transmits a request for a talk burst (a talk burst request message) to an associated PT server. Once the PT client receives the permission, then the PT client sends media data to one or more other PT clients with which a session has been established. The PT service allows user voice, moving picture and data communications to be shared with a single recipient (1-to-1) or between groups of recipients as in a group chat session (1-to-many), and uses a session initiation protocol (SIP) to establish a session.

In a PT system, a PT client (a client supporting a PT service) having a transmission authority among session-established clients transmits media through a PT server, and the other PT clients participating in the session receive the sent media.

According to a related art, a PT server can perform either a controlling function (Controlling PoC Function) or a participating function (Participating PoC Function), or can perform both the controlling function and the participating function. Such controlling function and participating function are known in the art. For the sake of clarity, the process/software/hardware responsible for implementing each of the controlling function and the participating function in the PT server is referred to as a controlling function part and a participating function part, respectively.

The controlling function part provides a centralized session handling, a media distribution, a talk burst control including a talker identification, a policy enforcement for participation in group sessions, and participant information. The participating function part provides a session handling and a policy enforcement for an incoming session, and may provide a media relay function and a talk burst control message relay function between the PT client and the controlling function part.

In case that n-PT clients are session-established at the PT server, the PT server includes n-participating function parts one-to-one corresponding to the n-PT clients (i.e., one participating function part for one PT client), and one controlling function part for controlling the PT clients through the participating function parts. The controlling function part and the participating function parts can exist in different PT servers depending on whether the clients participating in a session belong to one PT server region or to multiple PT server regions.

According to the related art, which PT server, among the different PT servers associated with the session-participating PT clients, should have the controlling function (i.e., should perform the controlling function) is determined during a PT session setup, and the determined PT server performs the controlling function for the duration of the entire PT session. In case of one-to-one PT session and an ad-hoc PT group session according to the related art, a PT server that has session-established with a user that requests the initialization of a session is automatically and always determined as the PT server having the controlling function. In case of a chat PT group session and a pre-arranged PT group session according to the related art, a PT server having a database for a group session or a PT server having a group identity is always and automatically determined as the PT server having the controlling function.

FIG. 1 is an exemplary view showing one example of a PT system according to a related art, wherein a PT server having a controlling function is determined by the above related art PT server determining method. FIG. 1 shows the amount of traffic (number of media sets) generated in case of implementing a PT service by session-establishing PT clients that belong to different PT server regions. One network may include one PT server region or multiple PT server regions.

Referring to FIG. 1, according to the related art method of determining which PT server should perform the controlling function as discussed above, a first PT server 10 covering a first PT server region is determined to always have the controlling function, e.g., because the first PT server 10 serves a first PT client 11 initiating the session.

In this example, the first PT client 11 that belongs to the first PT server region generates voice of one word. The arrow and the number in a box (31-36) between the first PT server region and a second PT server region and between the bearer packet network and the PT server denote respectively the transmission direction of media (voice) and the amount of traffic generated.

Referring to FIG. 1, when the voice at the first PT client 11 is transmitted to the first PT server 10 through a bearer packet network 16 (31), the first PT server 10 having the controlling function generates traffic (sets of media) as much as the number of the PT clients that are supposed to receive the voice (36, 32), in order to transmit the voice to all other the PT clients 13, 15, 21, 23, 25, 27, 29, and 31. For instance, in order to transmit the voice from the first PT client 11 to the second and third PT clients 13 and 15 of the first PT server region, the first PT server 10 generates two sets of media traffic (36)—one for the second PT client 13 and the other for the third PT client 15. Also, in order to transmit the voice from the first PT client 11 to the six PT clients 21, 23, 25, 27, 29, and 31 that exist in the second PT server region, the first PT server 10 generates six separate sets of media/traffic (32) and transmits them to the second PT server region through the bearer packet network 16 (33).

The six sets of media traffic transmitted to the second PT server region are then transmitted to a second PT server 20 through a bearer packet network 26 (34). The second PT server 20 then transmits the voice (six separate sets of media) respectively to the session-established six PT clients 21, 23, 25, 27, 29, and 31 in the second PT server region through the bear packet network 26 (35). As such, the first PT server 10 performs both the controlling function and the participating function since it receives the original voice from the first PT client 11 and also distributes it to other PT clients, whereas the second PT server 20 performs only the participating function.

According to the PT system of FIG. 1 wherein the first PT server 10 has the controlling function, and the three PT clients 11, 13, and 15 that belong to the first PT server region and the six PT clients 21, 23, 25, 27, 29, and 31 that belong to the second PT server region are session-established, a total of 27 different sets of media traffic (27=1+2+6+6+6+6) has to be generated just to transmit one voice of a specific PT client that belongs to the first PT server region to the other session-established PT clients, which is a significantly large amount of media traffic.

That is, the method of determining a controlling server (server having a controlling server) according to the related art does not produce an efficient and effective PT system. As aforementioned, in the related art method, the amount of every traffic generated in the PT system is not considered at all. This is a problem since it results in the generation of an unnecessarily large amount of traffic (27 sets of traffic in the example of FIG. 1). This increases system load and results in a lower transmission time for the session-established PT clients. Ultimately, the related art method places serious burden on the network system and inconveniences users since the media communication may be delayed or even lost.

### SUMMARY OF THE INVENTION

Therefore, an object of the present invention is to provide a method and system for determining a PT server having a controlling function, which are capable of decreasing the amount of traffic generated when media (e.g., signals, voice, video, data, etc.) is transmitted between session-established PT clients.

Another object of the present invention is to provide a method and system for determining a PT server having a controlling function, which overcome the limitations and disadvantages associated with the related art.

To achieve these and other advantages and in accordance with the purpose of the present invention, as embodied and broadly described herein, there is provided according to an embodiment of the present invention a method for determining a server having a controlling function, which can comprise: inviting at least one PT client to a session by a specific PT client; certifying the number of the invited PT clients on the basis of a PT server region by a PT server; and determining a PT server of a PT server region having the most PT clients as a PT server having a controlling function by the PT server.

According to an embodiment of the present invention, in the method for determining a server having a controlling function, in case of an ad-hoc group session, a PT server of a PT server region to which a PT client initiating the session belongs can make the determination of which PT server, among the multiple PT servers serving the session-establishing PT clients, should have the controlling function. In case of a chat PT group session and a pre-arranged PT group session, a PT server including a group identity or a PT server that requests an address list of PT client(s) corresponding to the group identity from a database, can make the determination of which PT server should have the controlling function. This determination can be made dynamically throughout the session such that the role of performing the controlling function can be switched from one PT server to another during the session depending on the circumstances, e.g., as the numbers of session-participating (session-invited) clients being served by the PT servers change throughout the session.

According to an aspect of the present invention, there is provided a method for determining a server having a controlling function for a session among at least two clients served by different servers, the method comprising: designating one of the different servers to be a server having a controlling function based on invited client information associated with the session, wherein the designated server is a server serving a highest number of clients invited to the session among the different servers.

According to another aspect of the present invention, there is provided a method for determining a server having a controlling function for a session among at least two clients served by at least two different servers, the method comprising: determining which server serves most clients invited to the session among the at least two different servers; and designating the determined server to be a server having a controlling function.

According to another aspect of the present invention, there is provided a method for determining a server having a controlling function for a session among at least two clients served by at least two different servers, the method comprising: changing, during the session, a designation of a server having a controlling function among the at least two different servers serving the at least two clients invited to the session, based on participating client information associated with the session.

According to another aspect of the present invention, there is provided a method of determining a server having a controlling function among a plurality of PT (push-to) servers, the method comprising: transmitting an invite message by a specific PT client; determining, by a PT server serving the specific PT client, the number of session-invited PT clients belonging to each of the PT servers for a session; and designating, by the specific PT server, a PT server having the most session-invited PT clients to have a controlling function, based on the determination result.

According to another aspect of the present invention, there is provided a method for determining a server having a controlling function, the method comprising: transmitting, by a specific PT (push-to) client, an invite message including a group identifier (ID) for identifying a group associated with a session; designating, by a PT server having the group ID, a PT server having a controlling function among a plurality of PT servers serving PT clients belonging to the group identified by the group ID, wherein the designated server is a server having most clients invited to the session among the plurality of PT servers; and transmitting, by the designated PT server having the controlling function, an invite message to each PT client belonging to the group.

According to another aspect of the present invention, there is provided a system for determining a server having a controlling function, the system comprising: a plurality of servers serving a plurality of clients in different server regions, the plurality of clients being invited to a session, wherein one of the servers is configured to designate one of the servers to be a server having a controlling function based on invited client information associated with the session, wherein the designated server is a server serving a highest number of clients invited to the session among the plurality of servers.

According to another aspect of the present invention, there is provided a system for determining a server having a controlling function, the system comprising: a plurality of servers serving a plurality of clients in different server regions, the plurality of clients being invited to a session, wherein one of the servers is configured to determine which server serves most clients invited to the session among the plurality of servers, and to designate the determined server to be a server have a controlling function.

According to another aspect of the present invention, there is provided a device for determining a server having a controlling function for a session among at least two clients served by at least two different servers, the device comprising: a processor configured to change during the session a designation of a server having a controlling function among the at least two different servers serving the at least two clients invited to the session, based on participating client information associated with the session.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is an exemplary view showing an amount of media traffic generated in a PT system in accordance with a related art;

FIG. 2 is an exemplary view showing an amount of media traffic generated in a PT system according to the present invention;

FIG. 3 is an exemplary view showing an amount of media traffic generated a PT system to which a method of determining a PT server having a controlling function is applied according to the present invention;

FIG. 4 is an exemplary view showing an amount of decrease in the media traffic generated when the method of determining a PT server having a controlling function is applied to the PT system according to the present invention;

FIG. 5 is a graph showing an example of a decrease rate of total media traffic generated according to the present invention;

FIG. 6 is an example of a signal flow chart showing a method and system for determining a PT server having a controlling function according to an embodiment of the present invention; and

FIG. 7 is an example of a signal flow chart showing a method and system for determining a PT server having a controlling function according to another embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

Hereinafter, a method and system for determining a server having a controlling function (e.g., a Controlling PoC Function) according to the present invention will be explained with reference to the attached drawings. In the present invention, the use of the term “PT” is intended to cover any PT type services including, but not limited to, a PTT service (voice), a PTV service (video), a PTD service (data), etc. At any given time of a session, only one server may have the controlling function; however, the present invention is applicable to other situations or variations thereof.

In a preferred embodiment of the present invention, in case of a PT system for providing a PT service to session-established PT clients included in different PT server regions, a PT server included in a PT server region having the most session-established PT clients is determined to be the PT server having the controlling function. That is, a PT server of a PT server region having the highest number of PT clients invited to a session among the different PT servers serving all the PT clients invited to the session, regardless of the type/kind of the session, is designated as the PT server having the controlling function (i.e., as the PT server designated to perform the controlling function). The session can be, but not limited to, an ad-hoc session, a chat-group session, a one-to-one session, a prearranged group session, etc. The terms like ‘session-established’ PT clients, ‘session-participating’ PT clients, ‘session-invited’ PT clients, and ‘invited’ PT clients are interchangeably used since in most cases, the number of each such clients would be the same. However, if they differ, the number of any one of such clients (e.g., session-invited or session-established) can be used as a basis to make the determination which PT server should have the controlling function.

Further, since a PT server of a PT server region having the most number of PT clients invited/participating to a session among all the different PT servers serving all the clients invited to the session is determined as the PT server having the controlling function, the designation of the PT server having the controlling function can be changed to designate a different PT server as the PT server having the controlling function, even during a session-establishment process or when the number of PT clients participated in the session is varied. As the numbers of session-invited PT clients associated with the different PT servers continue to vary depending on the time, situation, event, session, etc., the present method of determining which PT server should have the controlling function and designating that PT server as the controlling PT server can be applied as needed, continuously, or at certain intervals, etc. In such cases the controlling function may be performed by different PT servers as one of the different PT servers is designated as the controlling PT server at a given time.

In the method for determining a server having a controlling function according to a preferred embodiment of the present invention, in case of an ad-hoc group session, a PT server of a PT server region to which a PT client initiating the session belongs makes the determination of which PT server should have the controlling function. In case of a chat PT group session and a pre-arranged PT group session, a PT server including a group identity makes the determination of which PT server should have the controlling function. If an address list of PT client(s) corresponding to the group identity exists in an additional database outside the PT server, then a PT server that requests and receives the address list of the PT client corresponding to the group identity to and from the database can make the determination of which PT server should have the controlling function.

In the present invention, a PT server of a PT server region to which a PT client belongs can be defined as a PT server included in the home network of the PT client, or a PT server that provides a participating PT function to the PT client, or a PT server to which the PT client first accesses in case that a plurality of PT servers are used in one PT session.

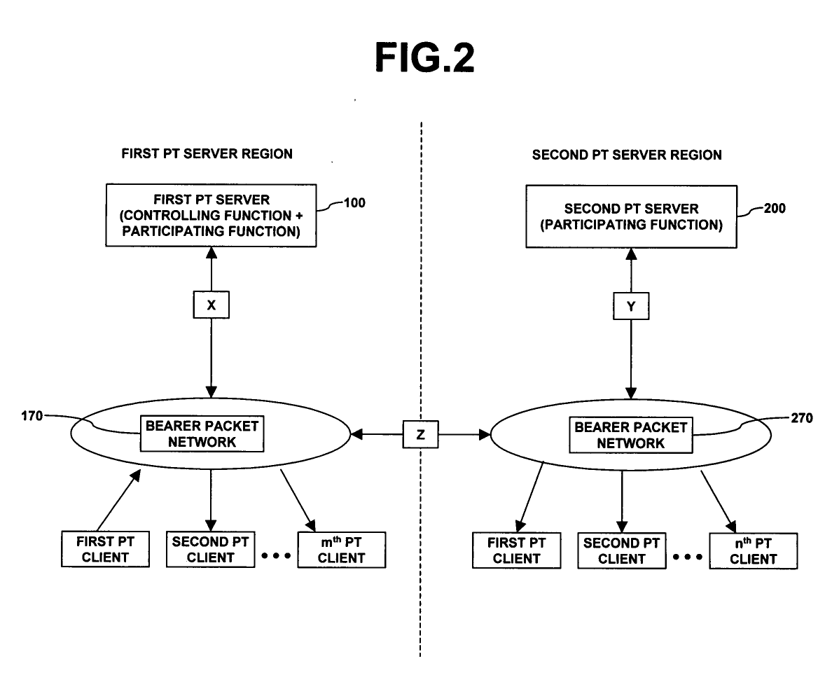

FIG. 2 is an exemplary view of a PT system showing a distribution of media traffic generated in a session in case that PT clients included in different PT server regions are session-established, according to the present invention. In this example, there are m PT clients invited to a session in a first PT server region, and n PT clients invited to the session in a second PT server region.

Referring to FIG. 2, when a specific PT client (first PT client) included in the first PT server region initiates a session and a first PT server 100 included in the first PT server region has a controlling function, sets of media traffic (X) corresponding to the number of PT clients (m+n) participated (invited) in the session are generated between the first PT server 100 and a bearer packet network 170. Also, between a second PT server 200 included in the second PT server region and a bearer packet network 270, sets of media traffic (Y) corresponding to two times of the number of invited PT clients (n) included in the second PT server region among the PT clients invited in the session are generated. Also, between the first PT server region and the second PT server region, sets of media traffic (Z) corresponding to the number of invited PT clients (n) of the PT server region to which the PT server having the controlling function (100) does not belong are generated.

That is, in order to transmit voice or other media generated from a specific PT client participated in the session to the rest PT clients participated in the session, the necessary amount of media traffic that needs to be generated is obtained by the following Formula 1, which is formulated by the present inventors:
TT=TC+(NC*3), [Formula 1]
where ‘TT’ represents the total amount of media traffic (sets of media traffic) generated in the different networks, ‘TC’ represents the total number of PT clients participated (invited) in a session, and ‘NC’ represents the number of invited PT clients of a PT server region to which a PT server having a controlling function does not belong. In the example of FIG. 2, TC=m+n, and NC=n.

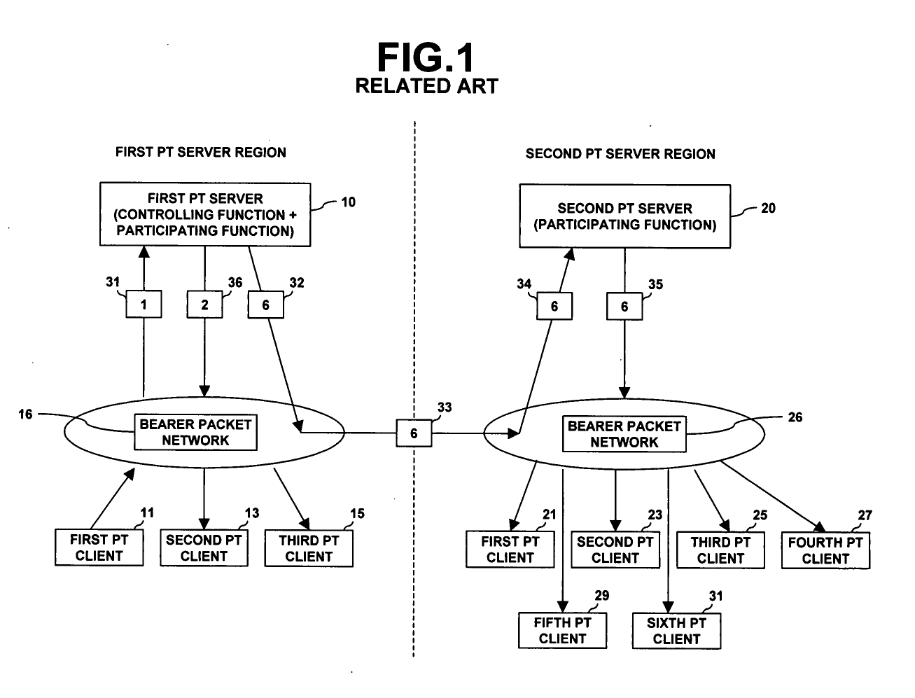

If Formula 1 is applied to the case shown in FIG. 1 where the number of the session-invited PT clients of the first PT server region is 3, the number of the session-invited PT clients of the second PT server region is 6, and the PT server of the first PT server region has the controlling function, then the total amount of media traffic generated in the session-established network is 27 (=9+(6*3)) according to Formula 1.

In the above Formula 1, when the number of the session-invited PT clients included in the PT server region to which the PT server having a controlling function does not belong is decreased, then the total number of media traffic sets is also decreased. Accordingly, in the present invention, to reduce this number, a PT server included in a PT server region having the most PT clients participated/invited in a session among the different PT servers serving the invited PT clients is determined as a PT server having a controlling function. If, for some reason, all the different PT servers have an equal number of invited PT clients, then the system can be configured to designate a particular server to have the controlling function or no change to the designation of the controlling PT server may be made from the previous or default designation.

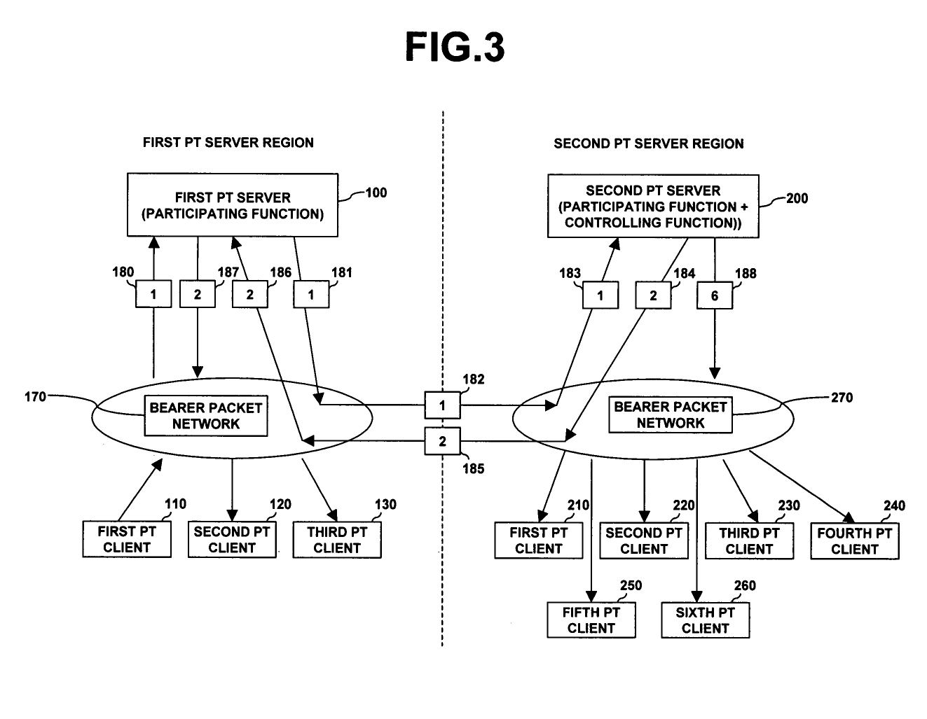

FIG. 3 is an exemplary view of a PT system showing the amount of media traffic generated when the method of determining a PT server having a controlling function according to the present invention is applied to the example of FIG. 1. All the components of the PT system of FIG. 3 are operatively coupled.

Referring to FIG. 3, according to the present invention, the system (e.g., one of the PT servers in the system) is configured to check the number of session-established PT clients being served by each PT server in a session, and to select the PT server that has the most number of the session-established PT clients among the different PT servers as the PT server having the controlling function. Then the selected PT server performs the controlling function for that session or a part thereof.

In the example of FIG. 3, three PT clients 110, 120, 130 in a first PT server region and six PT clients 210, 220, 230, 240, 250, 260 in a second PT server region have established a session with each other. In that case, the system selects or designates the second PT server 200 in the second PT server region as the PT server having the controlling function, because the second PT server 200 serves 6 session-established PT clients which is larger than 3 session-established PT clients served by the first PT server 100 in the first PT server region. As a result, the second PT server 200 serving the second PT server region having the most number of PT clients participated in the session is determined to be the PT server having the controlling function, and performs the controlling function during the session or a part thereof.

The amount of media traffic (number of sets of media traffic) generated during the session when the second PT server 200 performs the controlling function is illustrated in FIG. 3 with reference numerals 180-188. For instance, reference numeral 188 indicates there are six sets of media traffic generated and transmitted from the second PT server 200 to the bearer packet network 270.

In the example of FIG. 3, when voice is generated from the first PT client 110 of the first PT server region, the voice is transmitted to the first PT server 100 through the bearer packet network 170, and the first PT server 100 transmits the voice to the second PT server 200 through the bearer packet networks 170 and 270. The amount of traffic processed at this stage is indicated with reference numbers 180-183.

The second PT server 200 then generates 8 sets of media traffic (184 and 188) in order to transmit the voice (from the first PT client 110) to six invited PT clients 210, 220, 230, 240, 250, and 260 of the second PT server region and to two invited PT clients 120 and 130 of the first PT server region. That is, the second PT server 200, by performing the controlling function, transmits the voice from the first PT client 110 to all other session-established (invited) PT clients 120, 130, 210, 220, 230, 240, 250, and 260. The 2 sets of media traffic (184) from the second PT server 200 are transmitted to the first PT server 100 through the bearer packet networks 270 and 170 (185, 186). Then the first PT server 100, by performing the participating functions, transmits the received 2 sets of media (187) respectively to the second and third PT clients 120 and 130 through the bearer packet network 170. Similarly, the 6 sets of media traffic (188) from the second PT server 200 are transmitted respectively to the first through sixth PT clients 210-260 through the bearer packet network 270.

Thus, by designating the second PT server 200 as the PT server having the controlling function according to the method of the present invention, only 18 sets of media traffic (1+1+1+1+6+2+2+2+2=18) are generated in the PT system, thereby effectively and advantageously eliminating 9 sets of media traffic from the 27 media traffic sets generated in the related art FIG. 1.

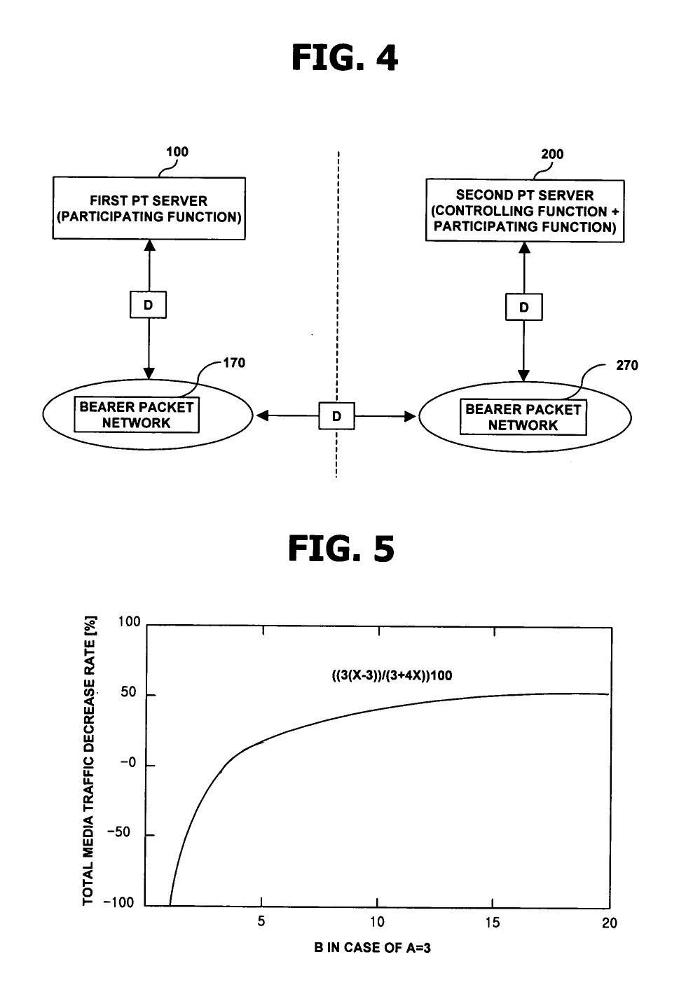

FIG. 4 is an exemplary view of a PT system showing a reduced amount of media traffic when the method of determining a PT server having a controlling function is applied to the PT system according to the present invention.

As discussed above, according to the present invention, if the number of invited PT clients in the second PT server region is more than the number of invited PT clients in the first PT server region, the second PT server 200 serving the second PT server region is determined as the PT server having the controlling function. Then the traffic between the first PT server 100 and the bearer packet network 170 of the first PT server region, between the bearer packet network 170 of the first PT server region and the bearer packet network 270 of the second PT server region, and between the second PT server 200 and the bearer packet network 270 of the second PT server region can be respectively decreased by as much as a difference D between the number of clients included in the regions according to Formula 2 below:
Total amount of decrease in media traffic=D*3 [Formula 2]
where ‘D’ denotes a difference between the number of invited PT clients included in a PT server region having more invited PT clients and the number of invited PT clients included in a PT server region having less invited PT clients.

When the example of FIG. 3 is applied to Formula 2, the total decrease in the amount of media traffic (i.e., the number of media traffic sets) generated is calculated to be 9 (=(6-3)*3). Accordingly, media can be transmitted to 8 PT clients included in the first PT server region and the second PT server region using only 18 sets of media traffic according to the present invention (27−3*3=18).

Formula 3 shows a decrease rate of media traffic generated when the method of determining a PT server having a controlling function according to the present invention is used:

$$\text{Total decrease rate of media traffic} = \frac{3 D}{A + 4 B} \times 100 = \frac{3 ( B - A )}{A + 4 B} \times 100 \qquad [ Formula 3 ]$$

where among a plurality of PT server regions, ‘A’ denotes the number of invited (participating) PT clients included in a PT server region having less PT clients participated in a session, ‘B’ denotes the number of invited (participating) PT clients included in a PT server region having more (or most) PT clients participated in the session, and ‘D’ denotes a value obtained by deducting A from B (i.e., D=B-A).

Also, according to the present invention, the total amount of media traffic generated if the PT server of the PT server region having less PT clients has a controlling function, can be obtained by adding the total number of PT clients participated in the session (A+B) to a value corresponding to three times of the number of PT clients included in the PT server region to which the PT server having a controlling function does not belong (3B). Then the total amount of media traffic in that case is calculated to be A+4B (=A+B+3B).

FIG. 5 is a graph showing the total decrease rate of media traffic generated in case that the number of invited PT clients of the PT server region having less invited PT clients (A) is 3 and the number of invited PT clients of the PT server region having more (or most) invited PT clients (B) is varied from 0 to 20.

Referring to FIG. 5, when the number of PT clients included in the PT server region having more PT clients (B) is 3, that is, when the number of PT clients included in the PT server region having more PT clients (B) is equal to the number of PT clients included in the PT server region having less PT clients (A), the decrease amount of media traffic is 0%. The more the number of the PT clients included in the PT server region having more PT clients (B) is increased, the more the decrease rate of media traffic is increased. For example, when A is 3 and B is 7, the decrease rate of media traffic generated in that case is approximately 38.7%. That is, by using the present method of determining which PT server should perform the controlling function, the amount of media traffic that needs to be generated to provide the PT service is reduced by approximately 38.7%, which is a significant reduction in the media traffic generated.

Although communication between two PT server regions are described, the present invention is equally applicable to more than two PT server regions. In this regard, the traffic decrease effect/advantage of the present invention is equally generated among at least three PT server regions, is equally generated during a PT session-establishment using a session initiation protocol (SIP) or a broadcasting function using the SIP message, and is equally generated in a talk burst control signaling using a real time control protocol (RTCP). The traffic decrease effect can be applied to all the traffic similar to the above traffic.

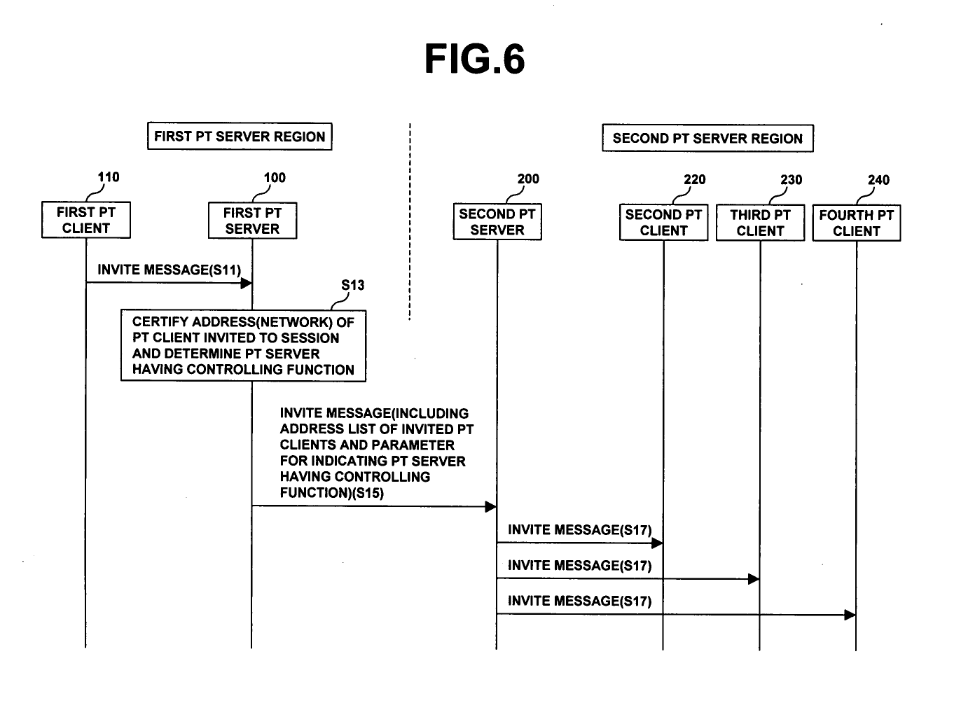

FIG. 6 is a signal flow chart showing a method of determining a PT server having a controlling function in case of an ad-hoc PT group session according to an embodiment of the present invention. This method is implemented in the PT system of FIG. 3, but is equally applicable to other PT systems.

In the related art ad-hoc PT group session, a PT server of a PT server region to which a PT client initiating the session belongs always had the controlling function. However, in the present invention, first a determination is made to see which PT server of a PT server region among multiple PT servers serving session-invited PT clients in multiple server regions has the highest number (most) of the session-invited PT clients. Then the determined PT server is designated to have the controlling function for that session or a part of that session.

In the example of FIG. 6, the first PT client 110 of the first PT server region generates an invite message (INVITE) in order to invite, e.g., the second PT client 220, the third PT client 230, and the fourth PT client 240 included in the second PT server region to a group session, and transmits the INVITE message to the first PT server 100 of the first PT server region (S11).

At step S11, the INVITE message transmitted by the first PT client 110 comprises a PT address list of all the invited PT clients 220, 230, and 240, media parameter(s) of the first PT client 110, a PT service indication, a PT address of the first PT client 110, and a talk burst control protocol proposal. The INVITE message optionally comprises a passive response resulting in an invalid request.

The first PT server 100 that has first received the INVITE message certifies a uniform resource identifier (URI) of the invited PT clients through the PT address list of the invited PT clients, and then respectively calculates the number of session-invited PT clients included in the first PT server region and the number of session-invited PT clients included in the second PT server region, and determines which PT server should have the controlling function based on the calculated information (S13). When the address is a SIP URI, a domain name and another method can be used to divide the network.

Particularly, the first PT server 100 that has certified the number of session-invited PT clients in the first PT server region and the number of session-invited PT clients in the second PT server region determines whether itself (the first PT server 100) should be the PT server having the controlling function or the second PT server 200 should be the PT server having the controlling function (S13) based on the number of session-invited PT clients in each of the PT server regions. In a preferred embodiment of the present invention, a PT server of a PT server region having more (or most) PT clients participated in a session is determined as the PT server having the controlling function.

In the example of FIG. 6, since the number (three) of session-invited PT clients 220, 230, and 240 included in the second PT server region is larger than the number of session-invited PT clients in the first PT server region, the first PT server 100 determines that the second PT server 200 should have the controlling function.

The first PT server 100 that has determined the second PT server 200 as the PT server having the controlling function then transmits an INVITE message to the second PT server 200 (S15), e.g., through the bearer networks, etc. This INVITE message includes a parameter informing/indicating that the second PT server 200 has the controlling function and the address list of all the PT clients 220, 230, and 240 invited to the session.

The second PT server 200 then respectively transmits an INVITE message to the second PT client 220, the third PT client 230, and the fourth PT client 240 invited to the session, whereby an ad-hoc PT group session begins (S17). At step S17, each INVITE message includes a destination address, i.e., the address of the corresponding PT client to which that INVITE message is directed.

The parameters included in the INVITE message transmitted to the second PT server 200 by the first PT server 100 are varied according to whether the first PT server 100 is the PT server having the controlling function or the second PT server 200 is the PT server having the controlling function. The two scenarios are discussed as follows and in both scenarios, it is assumed that the first PT client 110 in the first PT server region initiated the session as in step S11.

In a first case where the number of session-invited PT clients in the first PT server region is more than the number of session-invited PT clients in the second PT server region, the first PT server 100 recognizes itself to be the PT server having the controlling function (i.e., the first PT server 100 determines that the first PT server 100 itself will perform the controlling function). Then the first PT server 100 transmits an INVITE message to the second PT server 200 of the second PT server region. In that case, the INVITE message transmitted to the second PT server 200 by the first PT server 100 includes PT address(es) of session-invited PT client(s), media parameters of the first PT server 100, a PT service indication, a PT address of the first PT client 110, a controlling PT function indication parameter, a talk burst control protocol proposal, and a passive response resulting in an invalid request when the first PT client 110 is selected. In this regard, the first PT server 100 can generate a plurality of INVITE messages (may be couched in one INVITE message) to be respectively sent to the session-invited PT clients, where each INVITE message includes, among the above listed, the PT address of the corresponding PT client, and not the entire list of all the addresses of all the invited PT clients.

The generation of such an INVITE message can be implemented in different ways. As an example, the first PT server 100 can add, to the INVITE message received from the first PT client 110, the controlling PT function indication parameter and then transmit it to the second PT server 200 as its INVITE message. The controlling PT function indication parameter indicates which PT server has the controlling function, and includes an address of the PT server having the controlling function. In this case, the controlling PT function indication parameter includes an address of the first PT server 100, which is determined to perform the controlling function.

In a second case where the number of session-invited PT clients in the second PT server region is more than the number of session-invited PT clients in the first PT server region, the first PT server 100 recognizes that itself is not the PT server having the controlling function but the second PT server 200 is the PT server having the controlling function. Then the first PT server 100 transmits an INVITE message to the second PT server 200 of the second PT server region. In that case, the INVITE message transmitted to the second PT server 200 by the first PT server 100 include an address list of session-invited PT clients, a PT service indication, an address of the first PT client 110 (that generated the media), a controlling PT function indication parameter, a talk burst control protocol proposal, and a passive response resulting in an invalid request when the first PT client 110 is selected. The controlling PT function indication parameter includes an address of the second PT server 200, that is, a value informing that the second PT server 200 is the PT server having the controlling function.

In the above two scenarios, if the first PT server 100, which receives the list of addresses of the session-invited clients from the first PT client 110 initiating the session, is determined to be the PT server having the controlling function according to the method of the present invention, the first PT server 100 can transmit an INVITE message to each of all the PT clients to be invited to the session (e.g., some through the second PT server 200). In that case, each of the INVITE messages sent from the first PT server 100 includes the address of the corresponding PT client to be invited and not the entire list of client addresses.

However, if the second PT server 200 is determined to be the PT server having the controlling function according to the method of the present invention, the second PT server 200 has to first get the addresses of the invited PT clients in order to transmit the INVITE message to them. Accordingly, in that case, the INVITE message transmitted from the first PT server 100 to the second PT server 200 includes a list of addresses of all the PT clients to be invited to the session, and not just the address of one (corresponding) invited PT client.

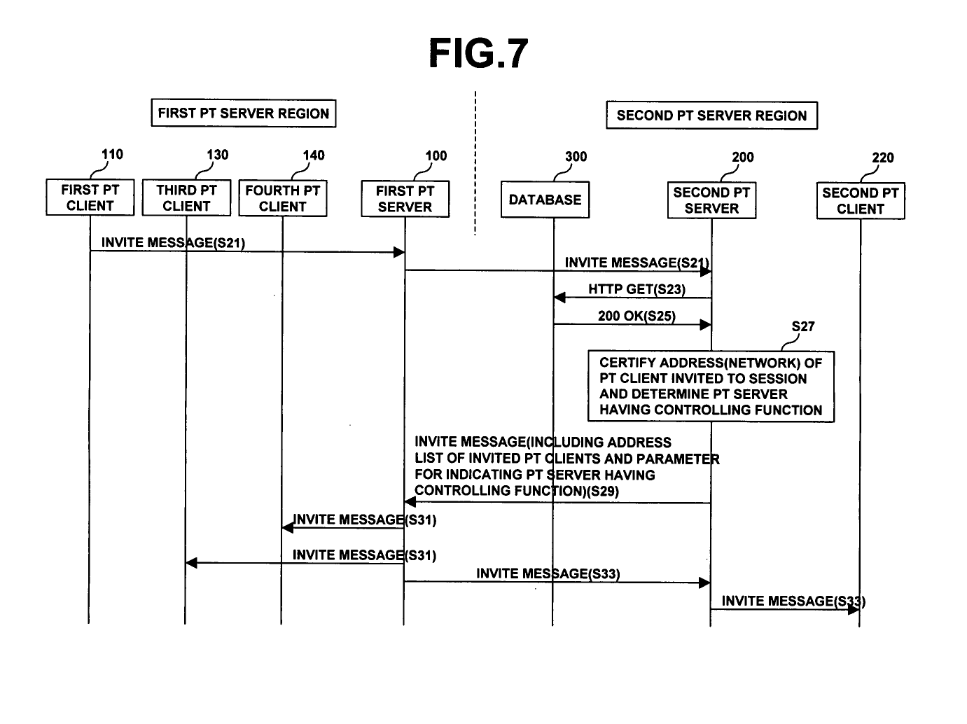

FIG. 7 is a signal flow chart showing a method of determining a PT server having a controlling function in case of a chat-group session or a pre-arranged group session according to another embodiment of the present invention. This method is implemented in the PT system of FIG. 3, but is equally applicable to other PT systems.

In the related art chat-group session or the pre-arranged group session, a PT server including a group identity (identity of the chat-group or pre-arranged group) always had the controlling function. However, in the present invention, among the plurality of PT server regions associated with the session, a PT server of a PT server region having more (or most) PT clients invited to the session is determined to have the controlling function.

An address list of the PT clients included in the group identity of the session may exist not only in a PT server but also outside the PT server, e.g., in a separate database. When such an address list exists outside the PT server (e.g., in an additional database), one or each of the session-established PT servers can request an address list of PT client(s) belonging to the group identified in the group identity (e.g., the name of the group) from the database, thereby to serve possibly as the PT server having the controlling function.

In the example of FIG. 7, a list of addresses of PT client(s) belonging to a chat-group or pre-arranged group is stored in a database 300. The database 300 in this example is an external database associated with the second PT server 200, but can be an internal database or an external database. In the database 300, this list can be stored in association with a group identify (e.g., the name of the chat-group or the pre-arranged group, etc.) so that it can retrieved by using the group identify. The database 300 may store a plurality of different lists of addresses for different chat-groups and different pre-arranged groups.

In the example of FIG. 7, a current chat-group session comprises the first PT client 110, the third client 130, the fourth client 140 of the first PT server region, and the second PT client 220 of the second PT server region. The second PT server 200 of the second PT server region requests an address list of all the PT client(s) corresponding to the group identity for the current chat-group session from the database 300.

More specifically, referring to FIG. 7, the first PT client 110 of the first PT server region transmits an INVITE message to the first PT server 100 to initiate a particular chat-group session. Then in order to request client address(es) for the requested chat-group session, the first PT server 100 transmits the INVITE message to the second PT server 200 (S21). At this step, the INVITE message transmitted to the first PT server 100 by the first PT client 110 includes a group identity for the chat-group session that the first PT client 110 is interested in, an address of the PT client 110 initiating the session, a PT service indication, media parameters of the first PT client 110, and a talk burst control protocol proposal.

Then the first PT server 100 transmits an INVITE message to the second PT server 200 (S21), e.g., through the bearer packet network(s). At this step, the INVITE message transmitted to the second PT server 200 by the first PT server 100 includes the group identity (e.g., chat group name, etc.) for the requested chat-group session, the address of the PT client 110 initiating the session, a PT service indication, media parameters of the first PT server 100, and a talk burst control protocol proposal.

The second PT server 200 that has received the INVITE message then requests and receives the address list of the PT client(s) corresponding to the identified group identity from the database 300, e.g., through an XML configuration access protocol (XCAP), an extension protocol in HTTP, thereby to certify URIs of PT clients to be invited to the chat-group session (S23, S25). Then, by examining the address list information, the second PT server 200 determines which PT server, among the different PT servers associated with the current chat-group session, has the most clients to be invited to the requested chat-group session and designates that PT server to have the controlling function according to the present invention (S27).

That is, the second PT server 200 respectively calculates the number of the PT clients (belonging to the identified chat group) in the second PT server region and the number of the PT clients (belonging to the identified chat group) in the first PT server region by using each address or each identifier of the PT clients in the list or by using a specific value for dividing home PT servers of the clients (S27). In this example, one PT client (220) is involved in the second PT server region, whereas three PT clients (110, 130, 140) are involved in the second PT server region for the requested chat group session. When the address or the identifier of the PT clients is a TEL uniform resource identifier (URI), local numbers allocated to each provider or each region can be used to divide the home PT servers of the clients. Also, when the address or the identifier of the PT clients is an SIP URI, a domain name can be used. A different for dividing the home PT servers of the clients can also be used.

The second PT server 200 that has certified the number of the invited PT clients in each PT server region determines whether itself is to be the PT server having the controlling function or the first PT server 100 of the first PT server region is to be the PT server having the controlling function. In the example of FIG. 7, since the number of the invited PT clients included in the first PT server region is larger than that in the second PT server region, the second PT server 200 determines that the first PT server 100 should have the controlling function.

The second PT server 200 that has determined the first PT server 100 as the PT server having the controlling function then transmits an INVITE message including a parameter indicating that the first PT server 100 has the controlling function and an address list of all the PT clients 130, 140, and 220 invited to the session, to the first PT server 100 (S29).

The first PT server 100, designated to perform the controlling function, respectively transmits the INVITE message to the third PT client 120 and the fourth PT client 130 invited to the session, and to the second PT client 210 through the second PT server 200 (S31, S33).

At step S29, a situation where the first PT server 100 has been determined to perform the controlling function has been discussed above. However, the parameters included in the INVITE message transmitted to the first PT server 100 by the second PT server 200 are varied according to whether the second PT server 200 is determined to be the PT server having the controlling function or the first PT server 100 is determined to be the PT server having the controlling function. The two scenarios are discussed below as follows.

In the first scenario where the second PT server 200 is designated to perform the controlling function, the second PT server 200 respectively transmits the INVITE message to the PT clients 130, 140, and 220 invited to the session, e.g., some through the first PT server 100. Accordingly, the INVITE message transmitted by the second PT server 200 to the first PT server 100 includes addresses of invited PT clients (130, 140), an address of the PT client 110 initiating the session, a PT service indication, media parameters of the second PT server 200, and a talk burst control protocol proposal. Since the second PT server 200 having the group identity is determined to be the PT server having the controlling function, the second PT server 200 need not inform its address.

In the second scenario where the first PT server 100 is designated to perform the controlling function, the second PT server 200 transmits an INVITE message including a parameter informing that the first PT server 100 has the controlling function and addresses of the PT clients 130, 140, and 220 invited to the session. That is, this INVITE message comprises an address list of all the invited PT clients 130, 140, and 220, an address of the PT client 110 initiating the session, a PT service indication, a talk burst control protocol proposal, and a controlling function informing parameter. The controlling function informing parameter can be a value indicating that the first PT server 100 has the controlling function, e.g., an address of the first PT server 100.

According to the existing/another embodiment, if the first PT server 100 has the controlling function and the address list of the invited PT clients corresponding to a group identity exists at an additional database, then the second PT server 200 may transmit to the first PT server 100 not the address list of the invited PT clients, but the group identity and parameter(s) for instructing the first PT server 100 to directly request from the additional database the address list of the PT clients corresponding to the group identity.

According to the existing/another embodiment, if the PT server that determines which PT server should have the controlling function (referred to herein as the determining PT server), and the PT server that actually has the controlling function have different session policies in the process of determining a PT server having a controlling function, the determining PT server includes its policies in a body of the INVITE message and transmits it to the PT server having the controlling function. Also, a policy of a PT server having no controlling function can be changed during the session, and the PT server having no controlling function can transmit the changed policy to the PT server having the controlling function. For example, the PT server having the controlling function periodically transmits a subscribe message to the PT server having no controlling function, and the PT server having no controlling function informs the changed policy to the PT server having the controlling function through a notify message for the subscribe message.

The policy information can include a session establishment policy for establishing a session, and a session joining policy applied when clients participate in the session.

In the session joining policy, in case of an ad-hoc or one-to-one PT session, the PT server having the controlling function allows clients that the session initiator invited, to participate in the session, and allows clients that were invited by themselves or another participant, to participate in the session. Also, in case of a pre-arranged group session, the PT server having the controlling function allows members of the group to participate in the session.

According to the present invention, the policy information can include the following policies besides the session joining policy.

First, a group participant may leave the PT group session. When the PT group session initiator leaves the PT group session, whether the PT group session should be ended or not would depend on the group policy.

Second, any PT participant may add any other PT user to any ongoing PT session, as long as the maximum number of participants is not exceeded and if allowed by the PT group policy.

Third, the PT server may decline the request to participate in the session based on policy information disallowing the requesting user to subscribe the participant information.

Fourth, based on some policy (e.g. the user has exceeded an allowed time limit), the PT server having the controlling function may support a policy of notifying a PT client when it is next in line for the permission to send a talk burst, e.g. in order to allow the PT client the opportunity to acquire radio resources in advance of being granted the permission to send a talk burst

Fifth, an allowed time limit to speak can be limited according to the policy information. The PT server having the existing controlling function transmits the policy information to a PT server having a new controlling function, thereby controlling PT clients included in different PT server regions according to each policy information.

According to an aspect of the present invention where a PT server of a PT server region having the most PT clients participated/invited in/to a session is designated as a PT server having a controlling function, the amount of media traffic generated in the session-established network can be decreased significantly.

According to another aspect of the present invention, when the traffic decrease effect may not be large since the difference between the numbers of PT clients included in each PT server region is small, the PT server having the controlling function may not be changed according to the number of the PT clients included in the PT server region. The policy for changing the PT server having a controlling function may be determined or changed by a service provider.

Also, according to the present invention, the role of the PT server having the controlling function can be transferred to another PT server during the session or before the session is finished, thereby establishing a method of dynamically determining a PT server having a controlling function. During/before the session, at certain intervals or times or when a certain event occurs or continuously, the PT system (e.g., the determining PT server) can be configured to check the number of PT clients involved in each of the different PT server regions and to determine, based on the checked numbers, if a new/different PT server should perform the controlling function. If so, the PT system can transfer all and any information/data necessary to perform the controlling function as needed, from the existing PT server previously designated to perform the controlling function to the different PT server newly designated to perform the controlling function. This process of checking the numbers of PT clients and designating one PT server to have the controlling function can be repeated at certain intervals or continuously or as many as needed during a session. In one example, the PT server previously designated to perform the controlling function can include all the information necessary to perform the controlling function in the body of the SIP message, and then transmit this information to the new PT server newly designated to perform the controlling function. This information can include a list of PT clients invited/participated in the session, a policy for controlling the session, etc.

In a preferred embodiment of the present invention, the PT server regions are limited to two. However, it is equally possible to implement the present invention in PT server regions that are three or more. Only as on example of implementation, if there are 4 PT server regions available, then the steps applied to between two PT server regions discussed above can be applied to one or more different combinations of any two PT server regions among the 4 PT server regions. In the alternative, all the PT servers regions may be evaluated at one time to determine which PT server in the regions is serving a highest number of invited PT clients for the session. Also, the present invention can be applied when the PT clients are session-established through at least two PT servers on one network.

As aforementioned, in the method and system for determining a server having a controlling function, a PT server of a PT server region having the most or more PT client among multiple PT servers associated with at least one session is determined as a PT server having a controlling function. Therefore, the amount of media traffic generated between the session-established PT clients can be decreased greatly.

Also, in the method and system for determining a server having a controlling function, a PT server having a controlling function can be changed dynamically to a different PT server even during the session, and a service quality can be enhanced by decreasing the amount of media traffic.

The calculating, determining, designating, and other processing steps of the present method of determining a server having a controlling server can be implemented with computer software written in existing computer programming language. Such computer program(s) may be stored in memories such as hard drive, RAM, ROM, PROM, etc. associated with computer(s) such as the PT server(s) discussed above, e.g., the PT server 100 (or a processor thereof) making the determination of which PT server should have the controlling function. Alternatively, such computer program(s) may be stored in a removable or portable storage medium such as a magnetic disc, optical disc, magneto-optical disc, etc. Such computer program(s) may also take the form of a signal propagating across the Internet, extranet, intranet or other network and arriving at the destination device for storage and implementation. The computer programs are readable and executable using a computer, a server, a processor in a server or a computer-based device.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A method for determining a server having a controlling function for a session among at least two clients served by different servers, the method comprising:
designating one of the different servers to be a server having a controlling function based on invited client information associated with the session, wherein the designated server is a server serving a highest number of clients invited to the session among the different servers.

2. The method of claim 1, wherein the invited client information includes identifiers uniquely identifying each of the at least two clients.

3. The method of claim 2, wherein the identifiers are uniform resource identifiers (URIs) of the at least two clients.

4. A method for determining a server having a controlling function for a session among at least two clients served by at least two different servers, the method comprising:
determining which server serves most clients invited to the session among the at least two different servers; and
designating the determined server to be a server having a controlling function.

5. The method of claim 4, wherein the controlling function involves a distribution of voice, video, image, signals, and/or data.

6. The method of claim 4, wherein the at least two clients are PT (push-to) clients and the at least two servers are PT servers.

7. The method of claim 6, wherein if the session is an ad-hoc group session, then the determining step is performed by a PT server serving a PT client initiating the session.

8. The method of claim 7, wherein in the designating step, if the PT server serving the PT client initiating the session is designated to be the server having the controlling function, the method further comprises:
transmitting, from the designated PT server to another PT server serving at least one of the invited PT clients, information notifying the another PT server that the designated PT server has the controlling function.

9. The method of claim 7, wherein in the designating step, if the PT server serving the PT client initiating the session is different from the PT server designated to be the server having the controlling function, the method further comprises:
transmitting, from the PT server serving the PT client initiating the session to the designated PT server, information for performing the controlling function.

10. The method of claim 9, wherein the information includes at least one of the following:
information notifying the designated PT server that the designated PT server has the controlling function;
an address list of all the PT clients invited to the session; or
policy information.

11. The method of claim 6, wherein if the session is a chat group session or a pre-arranged group session, the determining step is performed by a PT server capable of obtaining address information of all PT clients belonging to a group associated with the session.

12. The method of claim 11, wherein the determining step includes:
obtaining, from a database, the address information of all the PT clients belonging to the group associated with the session; and
examining the address information to make the determination.

13. The method of claim 12, wherein the database is an external database or an internal database.

14. The method of claim 11, wherein in the designating step, if the PT server having a group identifier for identifying the group associated with the session is designated to be the server having the controlling function, the method further comprises:
transmitting, from the PT server having the group identifier to another PT server serving at least one PT client belonging to the group, information notifying the another PT server that the PT server having the group identifier has the controlling function.

15. The method of claim 11, wherein in the designating step, if the PT server having a group identifier for identifying the group associated with the session is different from the PT server designated to be the server having the controlling function, the method further comprises:
transmitting, from the PT server having the group identifier to the designated PT server, information for performing the controlling function.

16. The method of claim 15, wherein the information includes at least one of the following:
information notifying the designated PT server that the designated PT server has the controlling function;
an address list of all the PT clients invited to the session; or
policy information.

17. The method of claim 6, wherein the determining step includes:
examining uniform resource identifier information of all the PT clients invited to the session to make the determination.

18. The method of claim 6, further comprising:
if the number of invited PT clients served by a PT server previously designated as having no controlling function becomes greater than the number of invited PT clients served by a PT server currently designated as having the controlling function, newly designating the PT server previously designated as having no controlling function as a new PT server having the controlling function.

19. The method of claim 18, further comprising:
transmitting, from the PT server previously designated as having the controlling function to the PT server newly designated as having the controlling function, information for performing the controlling function.

20. The method of claim 19, wherein the information includes at least one of the following:
information notifying the newly designated PT server that the newly designated PT server has the controlling function;
an address list of all the PT clients invited to the session; or
policy information.

21. A method for determining a server having a controlling function for a session among at least two clients served by at least two different servers, the method comprising:
changing, during the session, a designation of a server having a controlling function among the at least two different servers serving the at least two clients invited to the session, based on participating client information associated with the session.

22. The method of claim 21, wherein the changing step changes the designation of the server having the controlling server, if the number of clients served by a server currently having the controlling function is less than the number of clients served by any server having a participating function or having no controlling function.

23. The method of claim 21, wherein the controlling function involves a distribution of voice, video, image, signals, and/or data.

24. A method of determining a server having a controlling function among a plurality of PT (push-to) servers, the method comprising:
transmitting an invite message by a specific PT client;
determining, by a PT server serving the specific PT client, the number of session-invited PT clients belonging to each of the PT servers for a session; and
designating, by the specific PT server, a PT server having the most session-invited PT clients to have a controlling function, based on the determination result.

25. The method of claim 24, wherein the invite message comprises an address list of all PT clients invited to the session.

26. The method of claim 24, further comprising:
transmitting, from a home PT server of the specific PT client to the PT server designated to have the controlling function, information for performing the controlling function when the home PT server is different from the PT server designated to have the controlling function.

27. The method of claim 26, wherein the information for performing the controlling function includes at least one of the following;
information notifying the newly designated PT server that the newly designated PT server has the controlling function;
an address list of all the PT clients invited to the session; or
policy information.

28. The method of claim 26, wherein the session is an ad-hoc group session.

29. A method for determining a server having a controlling function, the method comprising:
transmitting, by a specific PT (push-to) client, an invite message including a group identifier (ID) for identifying a group associated with a session;
designating, by a PT server having the group ID, a PT server having a controlling function among a plurality of PT servers serving PT clients belonging to the group identified by the group ID, wherein the designated server is a server having most clients invited to the session among the plurality of PT servers; and
transmitting, by the designated PT server having the controlling function, an invite message to each PT client belonging to the group.

30. The method of claim 29, wherein the session is a chat group session or a pre-arranged group session.

31. The method of claim 29, wherein the designating step includes:
obtaining, from a database, address information of the PT clients belonging to the group identified by the group ID;
examining the address information; and
making a determination of which PT server serves most clients invited to the session among the plurality of PT servers, based on the examining result.

32. The method of claim 31, wherein the database is an external database or an internal database.

33. The method of claim 29, wherein in the designating step, if the PT server having the group ID is designated to be the PT server having the controlling function, the method further comprises:
transmitting, from the PT server having the group ID to another PT server serving at least one PT client belonging to the group, information notifying the another PT server that the PT server having the group ID has the controlling function.

34. The method of claim 29, wherein in the designating step, if the PT server having the group ID is different from the PT server designated to be the server having the controlling function, the method further comprises:
transmitting, from the PT server having the group ID to the designated PT server, information for performing the controlling function.

35. The method of claim 34, wherein the information includes at least one of the following:
information notifying the designated PT server that the designated PT server has the controlling function;
an address list of all the PT clients invited to the session; or
policy information.

36. A system for determining a server having a controlling function, the system comprising:
a plurality of servers serving a plurality of clients in different server regions, the plurality of clients being invited to a session,
wherein one of the servers is configured to designate one of the servers to be a server having a controlling function based on invited client information associated with the session, wherein the designated server is a server serving a highest number of clients invited to the session among the plurality of servers.

37. The system of claim 36, wherein the invited client information includes identifiers uniquely identifying each of the clients invited to the session.

38. The system of claim 37, wherein the identifiers are uniform resource identifiers (URIs) of the clients invited to the session.

39. A system for determining a server having a controlling function, the system comprising:
a plurality of servers serving a plurality of clients in different server regions, the plurality of clients being invited to a session,
wherein one of the servers is configured to determine which server serves most clients invited to the session among the plurality of servers, and to designate the determined server to be a server have a controlling function.

40. The system of claim 39, wherein the controlling function involves a distribution of voice, video, image, signals, and/or data.

41. The system of claim 39, wherein the plurality of clients are PT (push-to) clients and the plurality of servers are PT servers.

42. The system of claim 41, wherein if the session is an ad-hoc group session, then the one of the servers configured to determine is a PT server serving a PT client initiating the session.

43. The system of claim 42, wherein if the PT server serving the PT client initiating the session is designated to be the server having the controlling function, the system transmits, from the designated PT server to another PT server serving at least one of the invited PT clients, information notifying the another PT server that the designated PT server has the controlling function.

44. The system of claim 42, wherein if the PT server serving the PT client initiating the session is different from the PT server designated to be the server having the controlling function, the system transmits, from the PT server serving the PT client initiating the session to the designated PT server, information for performing the controlling function.

45. The system of claim 44, wherein the information includes at least one of the following:
information notifying the designated PT server that the designated PT server has the controlling function;
an address list of all the PT clients invited to the session; or
policy information.

46. The system of claim 41, wherein if the session is a chat group session or a pre-arranged group session, then the one of the servers configured to determine is a PT server capable of obtaining address information of all PT clients belonging to a group associated with the session.

47. The system of claim 46, further comprising:
a database, wherein the one of the servers configured to determine obtains, from the database, the address information of all the PT clients belonging to the group associated with the session, and examines the address information to make the determination.

48. The system of claim 47, wherein the database is an external database or an internal database.

49. The system of claim 46, wherein if the PT server having a group identifier for identifying the group associated with the session is designated to be the server having the controlling function, the system transmits, from the PT server having the group identifier to another PT server serving at least one PT client belonging to the group, information notifying the another PT server that the PT server having the group identifier has the controlling function.

50. The system of claim 46, wherein if the PT server having a group identifier for identifying the group associated with the session is different from the PT server designated to be the server having the controlling function, the system transmits, from the PT server having the group identifier to the designated PT server, information for performing the controlling function.

51. The system of claim 50, wherein the information includes at least one of the following:
information notifying the designated PT server that the designated PT server has the controlling function;
an address list of all the PT clients invited to the session; or
policy information.

52. The system of claim 41, wherein the one of the servers configured to determine examines uniform resource identifier information of all the PT clients invited to the session to make the determination.

53. The system of claim 41, wherein if the number of invited PT clients served by a PT server previously designated as having no controlling function becomes greater than the number of invited PT clients served by a PT server currently designated as having the controlling function, then the system newly designates the PT server previously designated as having no controlling function as a new PT server having the controlling function.

54. The system of claim 53, wherein the system transmits, from the PT server previously designated as having the controlling function to the PT server newly designated as having the controlling function, information for performing the controlling function.

55. The system of claim 53, wherein the information includes at least one of the following:
information notifying the newly designated PT server that the newly designated PT server has the controlling function;
an address list of all the PT clients invited to the session; or
policy information.

56. A device for determining a server having a controlling function for a session among at least two clients served by at least two different servers, the device comprising:
a processor configured to change during the session a designation of a server having a controlling function among the at least two different servers serving the at least two clients invited to the session, based on participating client information associated with the session.

57. The device of claim 56, wherein the processor is configured to change the designation of the server having the controlling server, if the number of clients served by a server currently having the controlling function is less than the number of clients served by any server having a participating function and having no controlling function.

58. The device of claim 56, wherein the controlling function involves a distribution of voice, video, image, signals, and/or data.
